(19) United States
(12) Patent Application Publication
(10) Pub. No.: US 2016/0344018 A1
(43) Pub. Date: Nov. 24, 2016

(54) ANODE MATERIAL COMPOSITION FOR A LITHIUM ION BATTERY

(71) Applicants: James Ching-Hua LI, (US); GET GREEN ENERGY CORP., LTD, Taichung City (TW)

(72) Inventors: Kuo-Feng CHIU, Taichung City (TW); Po-Nien LAI, Taichung City (TW)

(21) Appl. No.: 15/111,387

(22) PCT Filed: Sep. 10, 2014
(86) PCT No.: PCT/US14/54928

§ 371 Date: Jul. 13, 2016

(30) Foreign Application Priority Data
Jan. 13, 2014 (TW) 103101136

(51) Int. Cl. H01M 4/36; H01M 4/04; H01M 4/1395; H01M 4/62; H01M 4/38; H01M 4/587; H01M 4/66; H01M 10/0525; H01M 4/1393

(52) U.S. Cl. CPC H01M 4/364; H01M 10/0525; H01M 4/0404; H01M 4/043; H01M 4/0471; H01M 4/1395; H01M 4/1393; H01M 4/386; H01M 4/587; H01M 4/661; H01M 4/622; H01M 4/625; H01M 2004/027

(57) ABSTRACT

An anode material composition for a lithium ion battery includes: an active material unit including a graphite material and a silicon-containing material, the graphite material having a plurality of graphite particles, the silicon-containing material having a plurality of silicon flakes dispersed among the graphite particles; and an additive unit including a binder bonded to the graphite particles and the silicon flakes. The silicon flakes have a length and a thickness. The thickness of the silicon flakes ranges from 20 to 300 nm, and a ratio of the length to the thickness of the silicon flakes ranges from 2:1 to 2000:1.

### CROSS-REFERENCE TO RELATED APPLICATION

This application claims priority of Taiwanese Patent Application No. 103101136, filed on Jan. 13, 2014.

### BACKGROUND OF THE INVENTION

1. Field of the Invention

This invention relates to an anode material composition, more particularly to an anode material composition for a lithium ion battery.

2. Description of the Related Art

Lithium ion batteries are widely used in notebook computers, mobile phones, digital cameras, video cameras, personal digital assistants, Bluetooth headsets, and wireless 3C products. An anode of a conventional lithium ion battery mainly includes a carbonaceous material, such as mesocarbon microbeads (MCMBs, having a specific capacity of 310 mAh/g) and artificial graphite (having a specific capacity of 350 mAh/g). However, the full specific capacity of a carbon-based anode material has a theoretical value of 372 mAh/g, which cannot meet the requirement for high-power and high-energy density of future lithium ion batteries.

Compared to the carbon-based anode material or a graphite-based anode material, a silicon-containing anode material has a high theoretical specific capacity (3,800 mAh/g), approximately one order of magnitude higher than that of the graphite-based anode material (372 mAh/g). However, during charge and discharge of the lithium ion battery, the lithium ions undergo intercalation and de-intercalation on the silicon-containing anode material, which results in material expansion and contraction in the silicon-containing anode material. The conventional silicon-containing anode material includes silicon particles having a granular shape (i.e., non-flake-like particles) and a particle size in the order of several microns. The volume expansion of the conventional silicon-containing anode material may be up to 400% after being fully charged, which tends to cause cracking in the silicon-containing anode material and an increase in an internal impedance thereof, which, in turn, results in a decrease in the service life of the lithium ion battery.

Referring to FIG. 1, a conventional method of preparing a silicon-containing anode material 1 includes the steps of adding graphite particles 11 into a mixture solution of a solvent (not shown) and a binder 12, and then adding silicon particles 13 and a conductive carbon powder 14 into the mixture solution so as to mix and bind the graphite particles 11, the silicon particles 13 and the conductive carbon powder 14 together through the binder 12 to form a silicon-containing anode material 1. However, as shown in FIG. 1, aggregates of the silicon particles 13 among the graphite particles 11 of the silicon-containing anode material 1 obtained by the aforementioned conventional method are undesirably formed. The aggregates of the silicon particles 13 tend to cause a problem of cracking of the silicon-containing anode material 1 during intercalation of the lithium ions.

Therefore, there is still a need in the art for improving the service life of an anode material of a lithium ion battery.

### SUMMARY OF THE INVENTION

An object of the present invention is to provide an anode material composition for a lithium ion battery that can overcome the aforesaid drawback associated with the prior art.

According to the present invention, there is provided an anode material composition for a lithium ion battery. The anode material composition comprises: an active material unit including a graphite material and a silicon-containing material, the graphite material having a plurality of graphite particles, the silicon-containing material having a plurality of silicon flakes dispersed among the graphite particles; and an additive unit including a binder bonded to the graphite particles and the silicon flakes. The silicon flakes have a length and a thickness. The thickness of the silicon flakes ranges from 20 to 300 nm, and a ratio of the length to the thickness of the silicon flakes ranges from 2:1 to 2000:1.

### BRIEF DESCRIPTION OF THE DRAWINGS

In drawings which illustrate embodiments of the invention,

FIG. 1 is a schematic view of a conventional silicon-containing anode material;

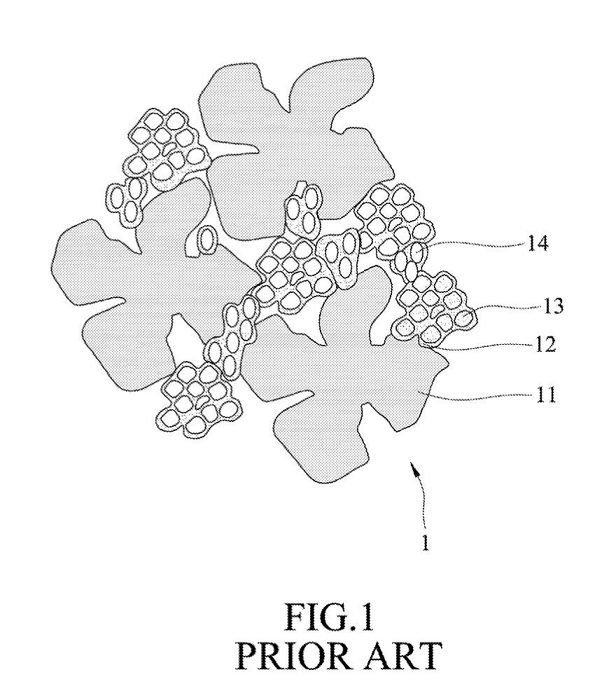

FIG. 2 is a schematic view of the first preferred embodiment of an anode material for a lithium ion battery according to the present invention;

FIG. 3 is a schematic view of the second preferred embodiment of the anode material for the lithium ion battery according to the present invention;

FIG. 4 is a SEM diagram illustrating the configuration of silicon flakes employed in an anode material of Example 1;

FIG. 5 is a SEM diagram illustrating the configuration of silicon flakes employed in an anode material of Example 2;

FIG. 6 is a SEM diagram illustrating the surface morphology of the anode material of Example 1;

FIG. 7 is a SEM diagram illustrating the surface morphology of an anode material of Comparative Example 1;

FIG. 8 is a plot of specific capacity vs. potential, illustrating the results of a charge-discharge cycle test for a lithium ion battery of Example 1;

FIG. 9 is a plot of specific capacity vs. potential, illustrating the results of a charge-discharge cycle test for a lithium ion battery of Example 2;

FIG. 10 is a plot of specific capacity vs. potential, illustrating the results of a charge-discharge cycle test for a lithium ion battery of Comparative Example 1;

FIG. 11 is a plot of specific capacity vs. potential, illustrating the results of a charge-discharge cycle test for a lithium ion battery of Comparative Example 2; and

FIG. 12 is a plot of the number of cycles vs. specific capacity, illustrating the results of the charge-discharge cycle test for the lithium ion battery of Example 1.

### DETAILED DESCRIPTION OF THE PREFERRED EMBODIMENTS

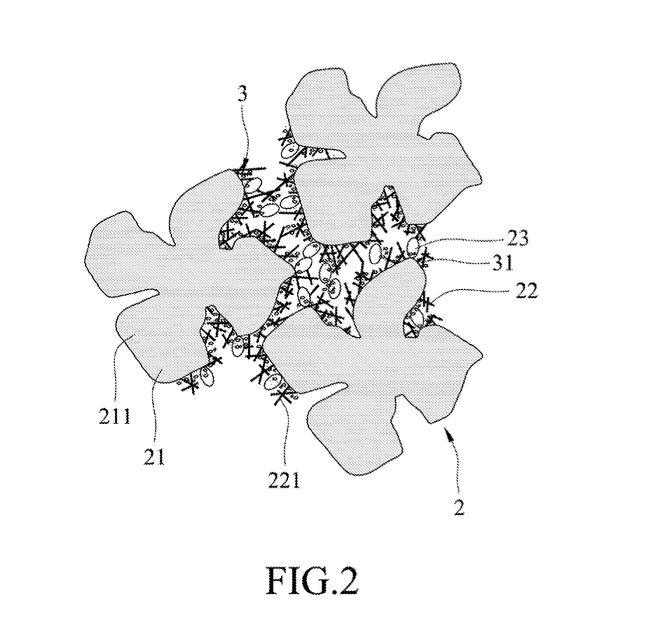

FIG. 2 illustrates the first preferred embodiment of an anode material for a lithium ion battery according to the present invention. The anode material has an anode material composition that comprises an active material unit 2 and an additive unit 3.

The active material unit 2 includes a graphite material 21 and a silicon-containing material 22. The graphite material 21 has a plurality of graphite particles 211. The silicon-containing material 22 has a plurality of silicon flakes 221 dispersed among the graphite particles 211. The additive unit 3 includes a first binder 31 bonded to the graphite particles 211 and the silicon flakes 221. The silicon flakes 221 have a length and a thickness. The thickness of the silicon flakes 221 ranges from 20 to 300 nm. A ratio of the length to the thickness of the silicon flakes 221 ranges from 2:1 to 2000:1.

It is noted that the silicon particles employed in the conventional anode material have a granular shape (i.e., non-flake-like shape) and tend to cause cracking of the anode material. For instance, the silicon particles with a diameter of 1 μm in an anode material of a lithium ion battery would expand in all directions when the anode material is intercalated with lithium ions during charging of the lithium ion battery. The diameter thereof expands about four times from 1 μm to 4 μm, which results in generation of a large internal stress in the anode material that leads to cracking of the anode material.

However, when the silicon flakes 221 having a thickness ranging from 20 to 300 nm (i.e., having relatively small volume) are used in the anode material composition of this invention, the volume expansion can be considerably reduced. For example, if the thickness of the silicon flakes 221 is 50 nm, when charging the lithium ion battery, the thickness of the silicon flakes 221 expands about four times from 50 nm to 200 nm, which is much smaller compared to expansion of the granular silicon particles and which results in generation of an internal stress that is much smaller than that of the expanded granular silicon particles. In addition, the flat shape of the silicon flakes 221 has advantages including: the silicon flakes have a relatively large surface area to accommodate more intercalated lithium ions thereon; and the silicon flakes 221 distributed among the graphite particles 211 may undergo rearrangement (such as moving toward and overlapping each other) due to the expansion of the silicon flakes 221 so as to mitigate a portion of the internal stress. Hence, during charge and discharge of the lithium ion battery, the planar structure of top and bottom surfaces of the silicon flakes 221 facilitates stacking of lithium ions thereon, thereby increasing the specific capacity of the lithium ion battery.

Preferably, as shown in FIG. 2, the graphite material 21 further comprises a conductive carbon powder 23 uniformly dispersed between the graphite particles 211 and the silicon flakes 221.

Preferably, the thickness of the silicon flakes 221 ranges from 50 to 100 nm, and the ratio of the length to the thickness of the silicon flakes 221 ranges from 10:1 to 2000:1.

Preferably, the additive unit 3 is in an amount ranging from 3 to 100 parts by weight based on 100 parts by weight of the active material unit 2.

Preferably, based on the weight of the active material unit 2, the silicon-containing material 22 is in an amount ranging from 0.5 to 90 wt %, and the graphite material 21 is in an amount ranging from 99.5 to 10 wt %.

Preferably, the first binder 31 is made from a material selected from the group consisting of polyolefin, fluorine-containing rubbers, non-fluorine-containing rubbers, cellulose derivatives, polysaccharide, water-soluble resins, and combinations thereof. More preferably, the first binder 31 is made from a material selected from the group consisting of polyvinylidene chloride, polyvinylidene fluoride (PVDF), polyfluoro vinylidene, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene polymer (EPDM), sulfonated ethylene-propylene-diene polymer, styrene butadiene rubber (SBR), fluorine rubber, and combinations thereof. Some materials of the first binder 31, e.g., styrene butadiene rubber, have hydrophilic groups, and thus exhibit hydrophilic property. Some materials of the first binder 31, e.g., polyvinylidene fluoride, have lipophilic groups, and thus exhibit lipophilic property. Most preferably, the material of the first binder 31 is selected from the group consisting of styrene butadiene rubber (SBR), carboxymethyl cellulose, and the combination thereof.

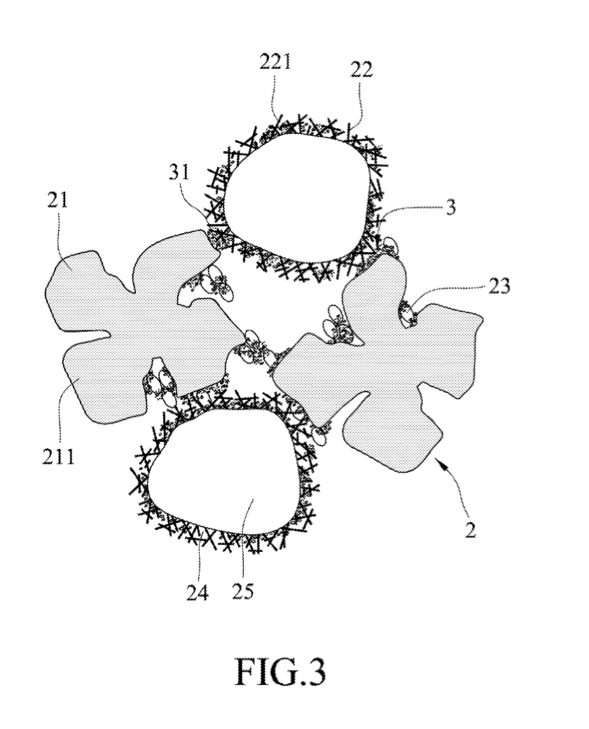

Preferably, as shown in FIG. 3, the silicon-containing material 22 further includes a plurality of stress-buffering particles 25 having a Young's modulus greater than 100 GPa. Each of the stress-buffering particles 25 is surrounded by and bonded to adjacent ones of the silicon flakes 221 which are randomly stacked and bonded to one another through a second binder 24. The silicon flakes 221 stacked on and bonded to a respective one of the stress-buffering particles 25 form a silicon-containing shell. The silicon-containing shell has a porous structure.

Preferably, the second binder 24 is the same as the first binder 31.

When the silicon-containing material 22 contains the stress-buffering particles 25, preferably, the stress-buffering particles 25 are in an amount ranging from 0.5 to 90 wt %, the second binder 24 is in an amount ranging from 0.5 to 20 wt %, and the silicon flakes 221 are in an amount ranging from 1 to 75 wt %, based on the weight of the silicon-containing material 22. More preferably, the stress-buffering particles 25 are in an amount ranging from 15 to 80 wt %, the second binder 24 is in an amount ranging from 1 to 15 wt %, and the silicon flakes 221 are in an amount ranging from 10 to 70 wt %, based on the weight of the silicon-containing material 22.

Preferably, the stress-buffering particles 25 are made from a material selected from the group consisting of silicon carbide (SiC), silicon nitride (Si₃N₄), titanium nitride (TiN), titanium carbide (TiC), tungsten carbide (WC), aluminum nitride (AlN), gallium, germanium, boron, tin, and indium. More preferably, the stress-buffering particles 25 are made from silicon carbide.

The merits of the preferred embodiments of this invention will become apparent with reference to the following Examples and Comparative Examples.

### EXAMPLES 1 AND 2 AND COMPARATIVE EXAMPLE 1

### Preparation of Anode Materials for Lithium Ion Batteries

### Example 1 (EX1)

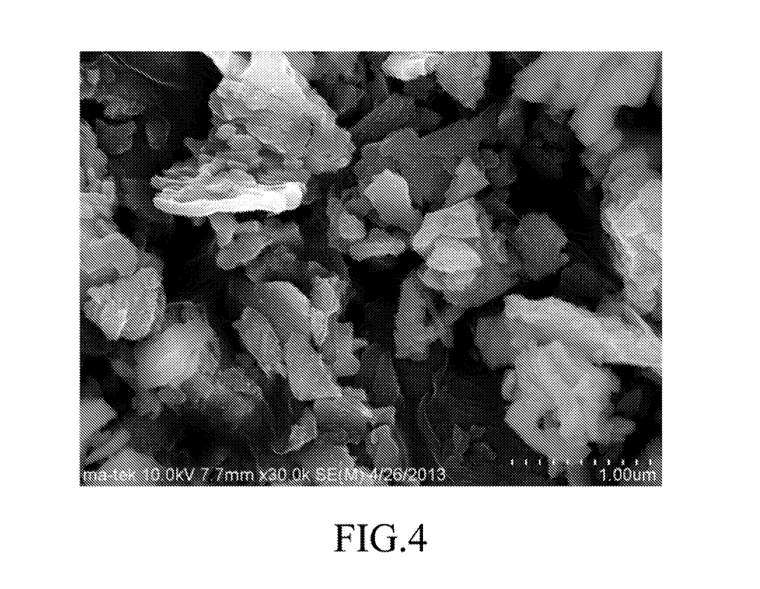

SBR (serving as the second binder) was dissolved in water to obtain a binder solution. Silicon flakes (cut from a silicon source using a wire saw, and having a thickness ranging from 100 to 300 nm, and a length ranging from 200 to 10,000 nm. FIG. 4 shows the morphology of the silicon flakes used in Example 1) were added into the binder solution under stirring to form a first mixture slurry.

After the silicon flakes were uniformly dispersed in the first mixture slurry, silicon carbide particles (serving as the stress-buffering particles) were then added into the first mixture slurry, followed by stirring evenly so that the stress-buffering particles were uniformly dispersed in the first mixture slurry and the silicon flakes were bonded to the stress-buffering particles to form a second mixture slurry containing a plurality of stress-buffering silicon-containing composite particles.

Carboxymethyl cellulose (serving as the first binder) was dissolved in water under stirring at 1000 rpm for an hour to obtain a carboxymethyl cellulose solution. Conductive carbon powder was added into the carboxymethyl cellulose solution under stirring at 4000 rpm for 30 minutes. After the conductive carbon powder was uniformly dispersed in the carboxymethyl cellulose solution, the second mixture slurry was added into the carboxymethyl cellulose solution, followed by stirring at 4000 rpm for 30 minutes so that the stress-buffering silicon-containing composite particles were uniformly dispersed in the carboxymethyl cellulose solution. Graphite particles were then added (particle size: 18 μm) into the carboxymethyl cellulose solution under stirring at 4000 rpm for 30 minutes to obtain an anode material paste containing the stress-buffering silicon-containing composite particles.

A disc-shaped copper foil having an area of 1.33 cm² was prepared to serve as a substrate. The substrate was cleaned to remove oxide and organic pollutants thereon. The cleaned substrate was immersed in a mixture of acetone and ethanol and was subjected to sonication to remove oil and other pollutants on the surface thereof. 3 mg of the anode material paste was applied to the disc-shaped copper foil, followed by drying to remove the solvent (water) and hot pressing to form an anode electrode (i.e., negative electrode) of Example 1.

The composition of the anode material paste of Example 1 is shown in Table 1.

The anode electrode of Example 1 was used as a working electrode and was assembled with a lithium-based electrode (serving as a counter electrode), a polypropylene (PP) isolation membrane, and a LiPF₆ electrolyte in a conventional manner for preparing a CR2032 type lithium ion battery.

### Example 2 (EX2)

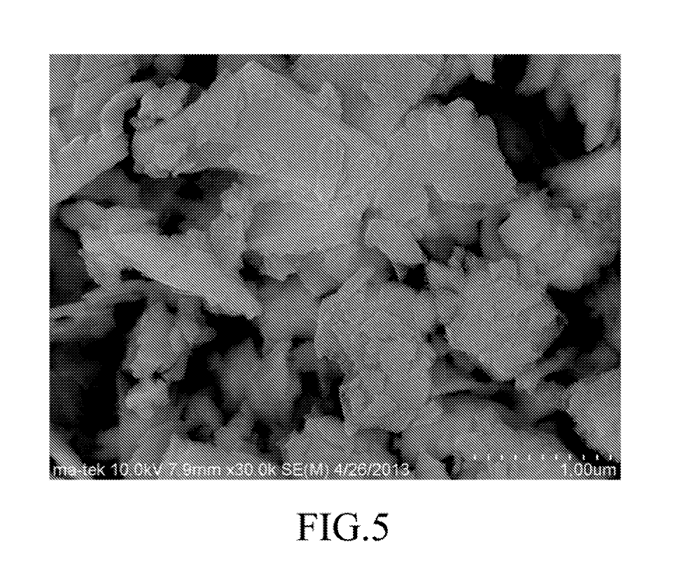

The procedures and conditions in preparing the anode material paste containing the stress-buffering silicon-containing composite particles, the anode electrode and the CR2032 type lithium ion battery of Example 2 were similar to those of Example 1, except for the thickness and the length of the silicon flakes used to form the stress-buffering silicon-containing composite particles. The silicon flakes employed in Example 2 have a thickness ranging from 50 to 100 nm, and a length ranging from 100 to 10,000 nm (FIG. 5 shows the morphology of the silicon flakes used in Example 2).

The composition of the anode material paste of Example 2 is shown in Table 1.

### Comparative Example 1 (CE1)

SBR (serving as the first binder) was dissolved in water to obtain a binder solution.

Graphite particles (having a particle size of 18 μm) and a conductive carbon powder were added into the binder solution, followed by stirring to obtain a first mixture slurry. Silicon particles (having a granular shape and a particle size of 1 μm) were added into the first mixture slurry, followed by stirring evenly so that the silicon particles were uniformly dispersed in the first mixture slurry to obtain an anode material paste containing a plurality of silicon particles.

A disc-shaped copper foil having an area of 1.33 cm² was prepared to serve as a substrate. The substrate was cleaned to remove oxide and organic pollutants on the surface thereof. The substrate was immersed in a mixture of acetone and ethanol, and was subjected to sonication to remove oil and other pollutants on the surface thereof. 3 mg of the anode material paste was applied to the disc-shaped copper foil, followed by drying to remove the solvent (water) and hot pressing to form an anode electrode of Comparative Example 1.

The procedures and conditions in preparing the anode electrode and the CR2032 type lithium ion battery of Comparative Example 1 were similar to those of Example 1.

The composition of the anode material paste of Comparative Example 1 is shown in Table 1.

### Comparative Example 2 (CE2)

The procedures and conditions in preparing the anode material composition containing the stress-buffering silicon-containing composite particles, the anode electrode and the CR2032 type lithium ion battery of Comparative Example 2 were similar to those of Example 1, except that granular silicon particles having a particle size of 1 μm were used instead of the silicon flakes in Comparative Example 2.

The composition of the anode material paste of Comparative Example 2 is shown in Table 1.

TABLE 1

| | | | EX1 | EX2 | CE1 | C2 |
|---|---|---|---|---|---|---|
| Silicon-containing | Stress- | Type | SiC | SiC | — | SiC |
| material | buffering | Amount (wt %) | 30 | 30 | — | 30 |
| (based on the weight | particle | | | | | |
| of the | Silicon- | Thickness | 100- | 50- | — | silicon |
| silicon-containing | containing | of silicon | 300 | 100 | | particles |
| material) | shell | flakes (nm) | | | | (particle |
| | | Length of | 200- | 100- | — | size of |
| | | silicon | 10,000 | 10,000 | | 1 μm) |
| | | flakes (nm) | | | | |
| | | Amount (wt %) | 67.5 | 67.5 | — | 67.5 |
| | Second | Type | SBR | SBR | — | SBR |
| | binder | Amount (wt %) | 2.5 | 2.5 | — | 2.5 |
| Active material | Graphite material | | 76.32 | 76.32 | 78.95 | 76.32 |
| unit | Conductive carbon | | 15.79 | 15.79 | 15.79 | 15.79 |
| (based on the weight | powder | | | | | |
| of the active | Silicon- | Type | stress- | stress- | silicon | stress- |
| material unit) | containing | | buffering | buffering | particles | buffering |
| (wt %) | material | | silicon- | silicon- | | particle |
| | | | containing | containing | | and silicon |
| | | | composite | composite | | particles |
| | | | particle | particle | | |
| | | Amount (wt %) | 7.89 | 7.89 | 5.26 | 7.89 |

| | | | | | |
|---|---|---|---|---|---|
| Anode material | Active material unit | 100 | 100 | 100 | 100 |
| paste (parts by | Additive unit | 5.26 | 5.26 | 5.26 | 5.26 |
| weight) | | | | | |

“—” means none or not available.

### Performance Test

### Charge-Discharge Cycle Test

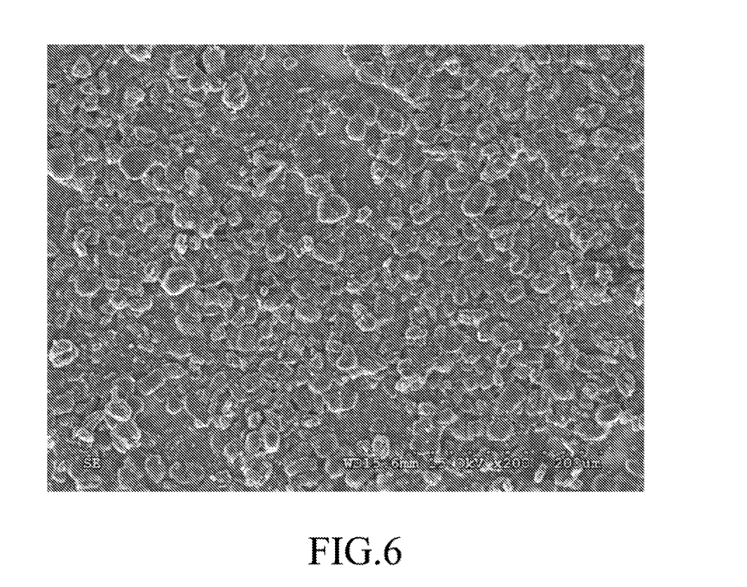

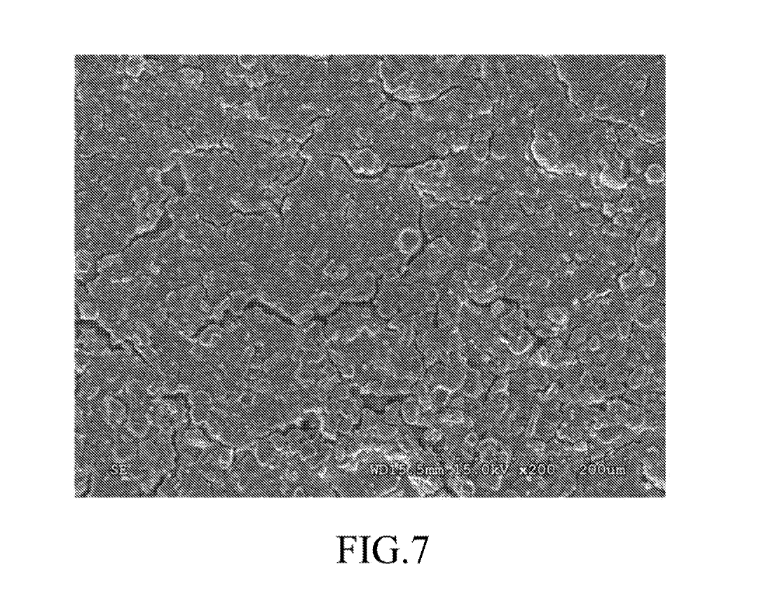

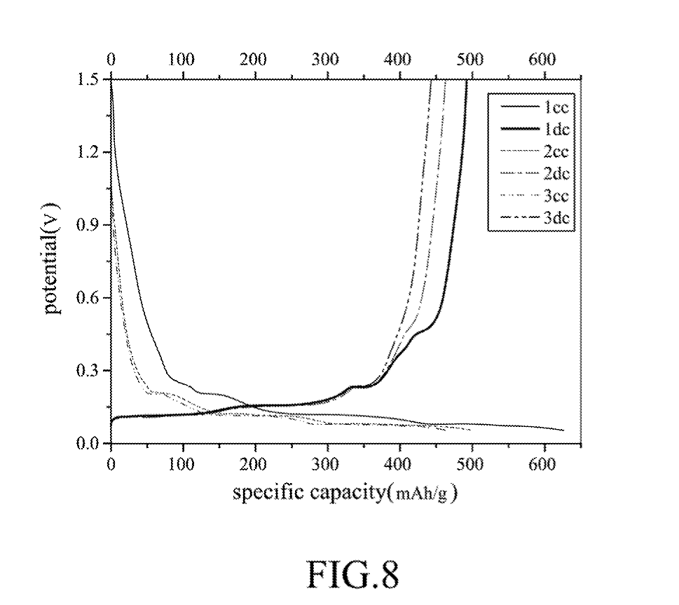

The lithium ion battery of each of Examples 1 and 2 and Comparative Examples 1 and 2 was subjected to a charge-discharge cycle test that was operated within a voltage cycle between 0V and 1.5V at a 0.1 C(Coulomb) rate under 25° C. FIG. 6 is an SEM diagram showing the surface morphology of the anode material of the lithium ion battery of Example 1 after a 250^{th} cycle of the charge-discharge operation. FIG. 7 is an SEM diagram showing the surface morphology of the anode material of the lithium ion battery of Comparative Example 1 after a 3^{rd} cycle of the charge-discharge operation. The results show that the anode material of Example 1 is free of cracks after the 250^{th} cycle, while the anode material of Comparative Example 1 is formed with several cracks. FIGS. 8 to 11 show the capacity characteristics of the charge-discharge cycle test for Examples 1 and 2 and Comparative Examples 1 and 2, respectively.

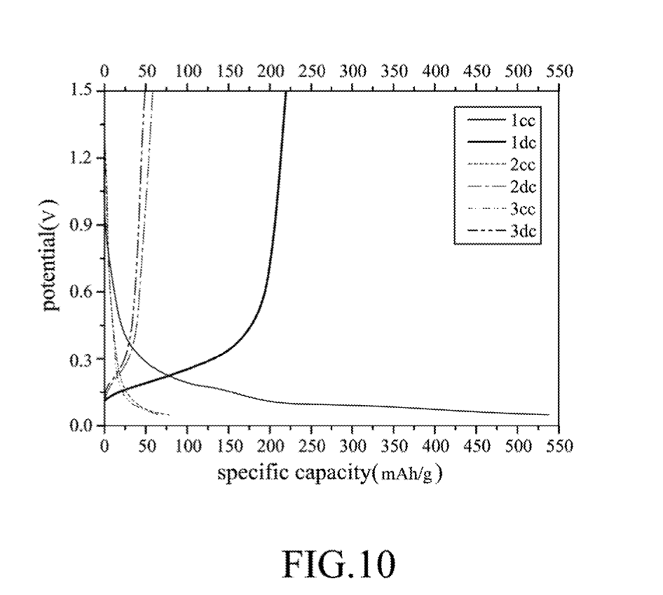

In FIGS. 8 to 11, the term “cc” represents charge, and the term “dc” represents discharge. As shown in FIG. 10, the specific capacity of Comparative Example 1 drops from about 535 mAh/g at the first cycle to about 80 mAh/g at the second cycle and further to about 60 mAh/g at the third cycle for charging operation, and drops from about 220 mAh/g at the first cycle to about 60 mAh/g at the second cycle and further to about 50 mAh/g at the third cycle for discharging operation.

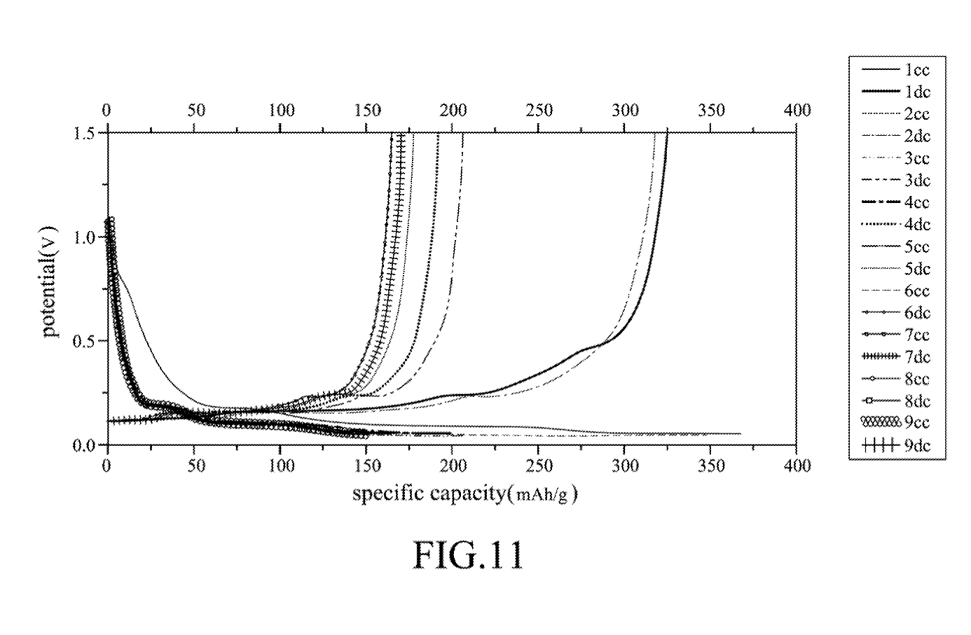

As shown in FIG. 11, the specific capacity of Comparative Example 2 drops from about 370 mAh/g at the first cycle to about 220 mAh/g at the third cycle and further to about 150 mAh/g at the ninth cycle for charging operation, and drops from about 325 mAh/g at the first cycle to about 210 mAh/g at the third cycle and further to about 170 mAh/g at the ninth cycle for discharging operation.

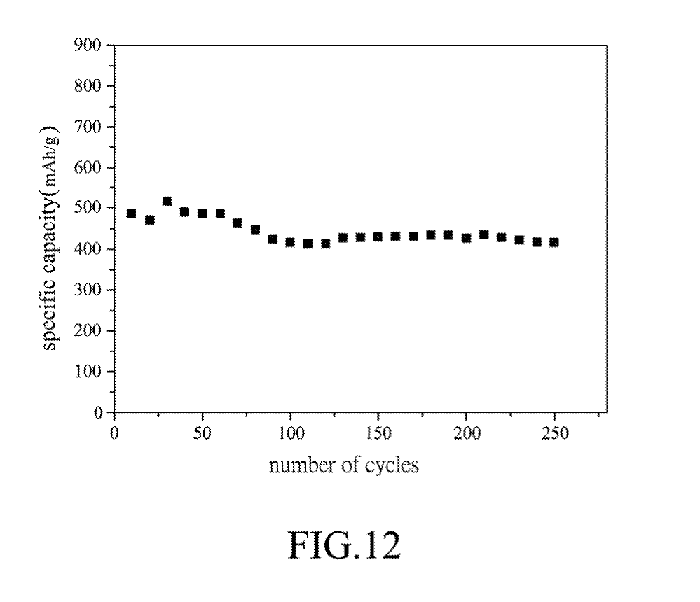

As shown in FIG. 8, in combination with FIG. 12, the specific capacity of Example 1 drops from about 620 mAh/g at the first cycle to about 450 mAh/g at the third cycle and further to about 400 mAh/g at the 250^{th} cycle (see FIG. 12) for charging operation, and drops from about 500 mAh/g at the first cycle to about 450 mAh/g at the third cycle and further to about 400 mAh/g (see FIG. 12) at the 250^{th} cycle for discharging operation.

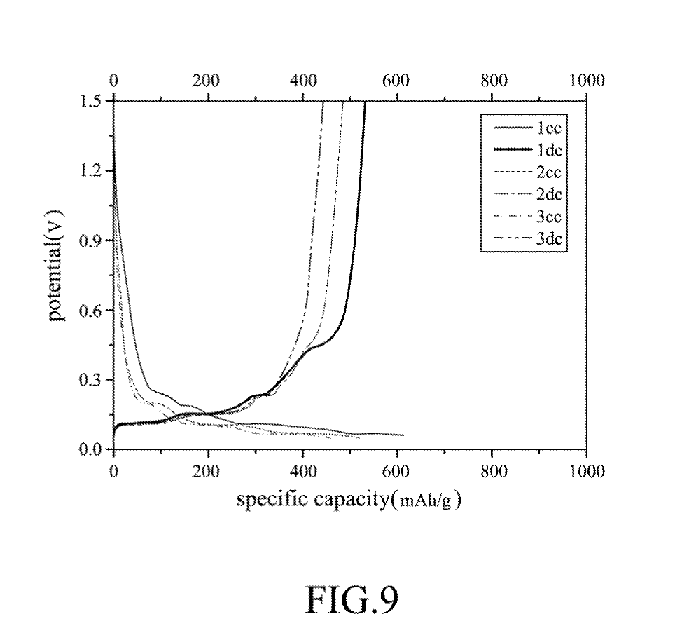

As shown in FIG. 9, the specific capacity of Example 2 drops from about 610 mAh/g at the first cycle to about 520 mAh/g at the second cycle and further to about 460 mAh/g at the third cycle for charging operation, and drops from about 530 mAh/g at the first cycle to about 490 mAh/g at the second cycle and further to about 440 mAh/g at the third cycle for discharging operation.

In conclusion, with the inclusion of the silicon flakes in the anode material composition of this invention for a lithium ion battery, the aforesaid drawback associated with the prior art can be alleviated.

With the invention thus explained, it is apparent that various modifications and variations can be made without departing from the spirit of the present invention. It is therefore intended that the invention be limited only as recited in the appended claims.

What is claimed is:

1. An anode material composition for a lithium ion battery, comprising:
an active material unit including a graphite material and a silicon-containing material, said graphite material having a plurality of graphite particles, said silicon-containing material having a plurality of silicon flakes dispersed among said graphite particles; and
an additive unit including a binder bonded to said graphite particles and said silicon flakes;
wherein said silicon flakes have a length and a thickness, the thickness of said silicon flakes ranging from 20 to 300 nm, a ratio of the length to the thickness of said silicon flakes ranging from 2:1 to 2000:1.

2. The anode material composition as claimed in claim 1, wherein said additive unit is in an amount ranging from 3 to 100 parts by weight based on 100 parts by weight of said active material unit.

3. The anode material composition as claimed in claim 1, wherein, based on the weight of said active material unit, said silicon-containing material is in an amount ranging from 0.5 to 90 wt %, and said graphite material is in an amount ranging from 99.5 to 10 wt %.

4. The anode material composition as claimed in claim 1, wherein said silicon-containing material further includes a plurality of stress-buffering particles having a Young's modulus greater than 100 GPa, each of said stress-buffering particles being surrounded by and being bonded to adjacent ones of said silicon flakes.

5. The anode material composition as claimed in claim 4, wherein said stress-buffering particles are made from a material selected from the group consisting of silicon carbide, silicon nitride, titanium nitride, titanium carbide, tungsten carbide, aluminum nitride, gallium, germanium, boron, tin, and indium.

6. The anode material composition as claimed in claim 4, wherein said stress-buffering particles are in an amount ranging from 0.5 to 90 wt % based on the weight of said silicon-containing material.

7. The anode material composition as claimed in claim 1, wherein said binder is made from a material selected from the group consisting of polyolefin, fluorine-containing rubbers, non-fluorine-containing rubbers, cellulose derivatives, polysaccharide, water-soluble resins, and combinations thereof.

8. The anode material composition as claimed in claim 7, wherein said binder is made from a material selected from the group consisting of polyvinylidene chloride, polyvinylidene fluoride, polyfluoro vinylidene, polyvinyl alcohol, carboxymethyl cellulose, starch, hydroxypropyl cellulose, regenerated cellulose, polyvinyl pyrrolidone, tetrafluoroethylene, polyethylene, polypropylene, ethylene-propylene-diene polymer, sulfonated ethylene-propylene-diene polymer, styrene butadiene rubber, fluorine rubber, and combinations thereof.
